(19) United States
(12) Patent Application Publication
(10) Pub. No.: US 2013/0221556 A1
(43) Pub. Date: Aug. 29, 2013

(54) DETECTOR, IMPRINT APPARATUS AND METHOD OF MANUFACTURING ARTICLE

(71) Applicant: CANON KABUSHIKI KAISHA, (US)

(72) Inventors: Takafumi Miyaharu, Utsunomiya-shi (JP); Kazuhiko Mishima, Utsunomiya-shi (JP)

(73) Assignee: CANON KABUSHIKI KAISHA, Tokyo (JP)

(21) Appl. No.: 13/775,323

(22) Filed: Feb. 25, 2013

(30) Foreign Application Priority Data
Feb. 27, 2012 (JP) 2012-040666

(51) Int. Cl. B29C 59/00; G01B 11/14

(52) U.S. Cl. CPC B29C 59/002; G01B 11/14
USPC 264/40.1; 356/498; 425/169

(57) ABSTRACT

A detector, which detects a relative position between a first object and a second object in a first direction, includes: an illumination optical system configured to obliquely illuminate a first mark arranged on the first object, and a second mark arranged on the second object; and a detection optical system configured to detect interfering light generated by light beams diffracted by the first mark and the second mark, respectively, illuminated by the illumination optical system. The illumination optical system forms a light intensity distribution including at least one pole on a pupil plane thereof. The detection optical system includes a stop provided with an aperture on a pupil plane thereof. A shape of the aperture includes a side parallel to the first direction.

### BACKGROUND OF THE INVENTION

1. Field of the Invention

The present invention relates to a detector which detects the relative position between two different objects, an imprint apparatus, and a method of manufacturing an article.

2. Description of the Related Art

In the imprint techniques, a fine pattern is formed on a substrate using a mold having a fine pattern formed on it. An example of the imprint techniques is the photo-curing method. In the imprint technique which uses the photo-curing method, first, a resin (imprint resin or light curable resin) as an imprint material is supplied to a shot as an imprint region on a substrate. The resin is irradiated with light while the pattern formed on a mold is kept in contact with the resin (the mold is pressed against the resin) to cure the resin. The mold is separated (released) from the cured resin to form a pattern of the resin on the substrate.

To bring the mold into contact with the resin on the substrate, it is necessary to accurately align the substrate and the mold. As a scheme of aligning the substrate and the mold in the imprint apparatus, the so-called die-by-die alignment scheme in which alignment is done by detecting a mark formed on the mold and a mark formed on the substrate for each shot is known.

U.S. Pat. No. 7,292,326 describes an imprint apparatus including a detector which detects an alignment mark. Grid patterns are respectively arranged on a mold and substrate as alignment marks. The mark on the mold includes a grid pattern having a grid pitch in the measurement direction. The mark on the substrate includes a checkerboard grid pattern having grid pitches in the measurement direction and a direction (non-measurement direction) perpendicular to the measurement direction. Both an illumination optical system which illuminates the mark, and a detection optical system which detects light diffracted by the mark are arranged to be tilted from a direction perpendicular to the mold and substrate toward the non-measurement direction. That is, the illumination optical system is configured to obliquely illuminate the mark in the non-measurement direction. Light obliquely incident on the mark is diffracted by the checkerboard grid pattern arranged on the substrate, and the detection optical system is arranged to detect only diffracted light of a specific order other than zero in the non-measurement direction.

The imprint apparatus adopts TTM (Through The Mold) alignment, in which the mark on the substrate is observed through the mark arranged on the mold. When dark-field illumination in which light beams diffracted by the mark on the mold and the mark on the substrate are detected is used, it is difficult to increase the amount of light. Also, depending on the wavelength range, a diffracted light beam having +1st-order diffraction and a diffracted light beam having −1st-order diffraction are eclipsed in different regions by a detection aperture. Therefore, a region, where one of the ±1st-order diffractions does not interfere with the other of the ±1st-order diffractions, is generated, and thus diffracted light beam which does not contribute to interference is detected. As a result, the contrast is lowered due to the diffracted light beam which does not contribute to interference.

### SUMMARY OF THE INVENTION

The present invention provides a detector which detects the relative position between two objects with high accuracy.

The present invention in its one aspect provides a detector which detects a relative position between a first object and a second object in a first direction, the detector comprising: an illumination optical system configured to obliquely illuminate a first mark arranged on the first object, and a second mark arranged on the second object; and a detection optical system configured to detect interfering light generated by light beams diffracted by the first mark and the second mark, respectively, illuminated by the illumination optical system, wherein the illumination optical system forms a light intensity distribution including at least one pole on a pupil plane thereof, the detection optical system includes a stop provided with an aperture on a pupil plane thereof, and a shape of the aperture includes a side parallel to the first direction.

Further features of the present invention will become apparent from the following description of exemplary embodiments with reference to the attached drawings.

### BRIEF DESCRIPTION OF THE DRAWINGS

FIGS. 1A to 1D are views for explaining the effect of the present invention;

FIG. 2 is a view showing the configuration of an imprint apparatus;

FIG. 3 is a view illustrating an example of a detector;

FIG. 4 is a view illustrating another example of the detector;

FIG. 5 is a view showing the pupil distribution of the detector;

FIGS. 6A to 6D are views showing marks which generate moire fringes;

FIG. 7 is a view showing marks for alignment in the X-direction;

FIGS. 8A to 8D are views showing the states of diffracted light beams;

FIG. 9 is a view showing marks for alignment in the Y-direction;

FIG. 10 is a view showing moire fringes for alignment in the X- and Y-directions;

FIG. 11 is a view for explaining the constraint of the pupil shape;

FIGS. 12A and 12B are views illustrating an example of the pupil distributions of the detector; and

FIGS. 13A and 13B are views illustrating another example of the pupil distributions of the detector.

### DESCRIPTION OF THE EMBODIMENTS

Modes for carrying out the present invention will be described below with reference to, for example, the accompanying drawings.

[Detector & Imprint Apparatus]

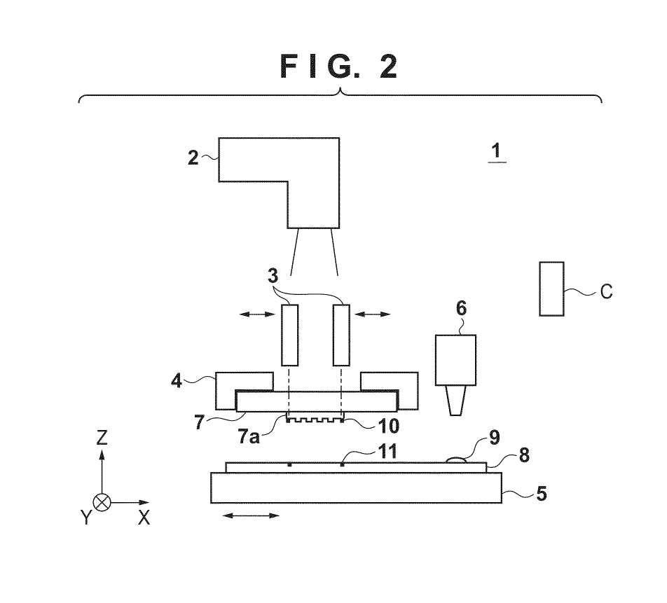

The configuration of an imprint apparatus will be described with reference to FIG. 2. An imprint apparatus 1 is employed to manufacture a device such as a semiconductor device, and molds an uncured resin (imprint material) 9, on a substrate (wafer) 8 to be processed, using a mold 7 to form (transfer) a pattern of the resin 9 on the substrate 8. Note that the imprint apparatus in this embodiment adopts the photo-curing method. Also, in the following drawings, orthogonal X- and Y-axes are defined within a plane parallel to the surface of the substrate 8, and a Z-axis is defined in a direction perpendicular to the X- and Y-axes. The imprint apparatus 1 includes an ultraviolet irradiation unit 2, detector 3, mold holding unit 4, substrate stage 5, and dispensing unit (dispenser) 6.

After a press process of bringing the mold 7 into contact with the resin 9 on the substrate 8, the ultraviolet irradiation unit 2 irradiates the mold 7 with ultraviolet rays to cure the resin 9. The ultraviolet irradiation unit 2 includes a light source (not shown), and a plurality of optical elements (not shown) for uniformly irradiating a pattern surface 7a of the mold 7 with ultraviolet rays, emitted by the light source, in a predetermined shape. Especially the region irradiated with ultraviolet rays by the ultraviolet irradiation unit 2 desirably is nearly equal to or slightly larger than the surface area of the pattern surface 7a. This is to set a minimum area required for the region irradiated with ultraviolet rays so as to prevent the occurrence of a position shift or distortion in the pattern transferred onto the resin 9 as the mold 7 or substrate 8 expands due to heat upon irradiation. In addition, this is to prevent the occurrence of an abnormality in the operation of the dispensing unit 6 (to be described later) as the ultraviolet rays reflected by, for example, the substrate 8 reach the dispensing unit 6 and cure the resin 9 remaining in the discharge portion of the dispensing unit 6.

A high-pressure mercury lamp or various excimer lamps, excimer lasers, or light-emitting diodes, for example, can be adopted as the light source. Although the type of light source is appropriately selected in accordance with the property of the resin 9, the present invention is not limited by, for example, the types, number, or wavelengths of light sources.

A predetermined pattern (for example, a three-dimensional pattern such as a circuit pattern) is three-dimensionally formed on the surface of the mold 7, which is to face the substrate 8. The material of the mold 7 is, for example, quartz that can transmit ultraviolet rays.

The mold holding unit 4 draws and holds the mold 7 by a vacuum suction force or an electrostatic force. The mold holding unit 4 includes a mold chuck, a driving mechanism which drives the mold chuck in the Z-direction to press the mold 7 against the resin 9, and a correction mechanism which deforms the mold 7 in the X- and Y-directions to correct the distortion of the pattern transferred onto the resin 9.

The mold 7 and substrate 8 serve as first and second objects, respectively, which are spaced apart from each other in the Z-direction in an X-Y-Z coordinate system. The press and release operations of the imprint apparatus 1 may be implemented by moving the mold 7 in the Z-direction, but may be implemented by moving the substrate stage 5 in the Z-direction or by moving both of them. The substrate stage 5 holds the substrate 8 by, for example, vacuum suction and is movable within the X-Y plane. The substrate 8 is made of, for example, single-crystal silicon, and an ultraviolet-curing resin 9 molded by the mold 7 is dispensed onto the surface of the substrate 8 to be processed.

The imprint apparatus 1 includes the detector 3 which detects the relative positional relationship between the mold 7 and the substrate 8. The detector 3 optically detects marks 10 and 11 arranged on the mold 7 and substrate 8, respectively, to detect their relative position. The optical axis of the detector 3 is perpendicular to the surface of the substrate 8. The detector 3 can be driven in the X- and Y-directions in accordance with the positions of the marks 10 and 11 arranged on the mold 7 and substrate 8, respectively. Also, the detector 3 can be driven in the Z-direction to focus the optical system on the positions of the marks 10 and 11. Driving of correction mechanisms of the substrate stage 5 and mold 7 is controlled based on the relative position between the mold 7 and the substrate 8 measured by the detector 3. The detector 3 and the marks 10 and 11 for alignment will be described in detail later.

The dispensing unit 6 dispenses an uncured resin 9 onto the substrate 8. The resin 9 is a light curable resin having the property that it cures upon receiving ultraviolet rays, and is appropriately selected in accordance with, for example, the type of semiconductor device. Instead of building the dispensing unit 6 into the imprint apparatus 1, as shown in FIG. 2, a dispensing device may be separately provided outside the imprint apparatus 1, and substrate 8 on which the resin 9 is dispensed in advance by the dispensing device may be charged into the imprint apparatus 1. This obviates the need for a dispensing process in the imprint apparatus 1, thus speeding up the process in the imprint apparatus 1. Also, since the dispensing unit 6 becomes unnecessary, it is possible to keep the manufacturing cost of the overall imprint apparatus 1 low.

An imprint process by the imprint apparatus 1 will be described. First, a controller C transports the substrate 8 onto the substrate stage 5 using a substrate transport unit (not shown), and fixes it onto the substrate stage 5. The controller C moves the substrate stage 5 to the dispensing position of the dispensing unit 6, which dispenses the resin 9 to a predetermined shot (imprint region) on the substrate 8 as a dispensing process. The controller C moves the substrate stage 5 so that the dispensing surface on the substrate 8 is positioned immediately below the mold 7.

The controller C drives the driving mechanism of the mold 7 to press the mold 7 against the resin 9 on the substrate 8 (press process). At this time, the resin 9 flows along the pattern surface 7a formed on the mold 7 upon the press of the mold 7. Further, in this state, the detector 3 detects the marks 10 and 11 arranged on the substrate 8 and mold 7, respectively, and the controller C performs, for example, alignment between the mold 7 and the substrate 8 by driving the substrate stage 5, and correction using the correction mechanism of the mold 7. When the flow of the resin 9 onto the pattern surface 7a, the alignment between the mold 7 and the substrate 8, and the correction of the mold 7, for example, have sufficiently take place, the ultraviolet irradiation unit 2 irradiates the mold 7 with ultraviolet trays from its back surface (upper surface), so the resin 9 cures with the ultraviolet rays transmitted through the mold 7 (curing process). At this time, the detector 3 is retreated so as not to block the optical path of the ultraviolet rays. The driving mechanism of the mold 7 is driven again to release the mold 7 from the substrate 8 (release process), thereby transferring the three-dimensional pattern of the mold 7 onto the substrate 8.

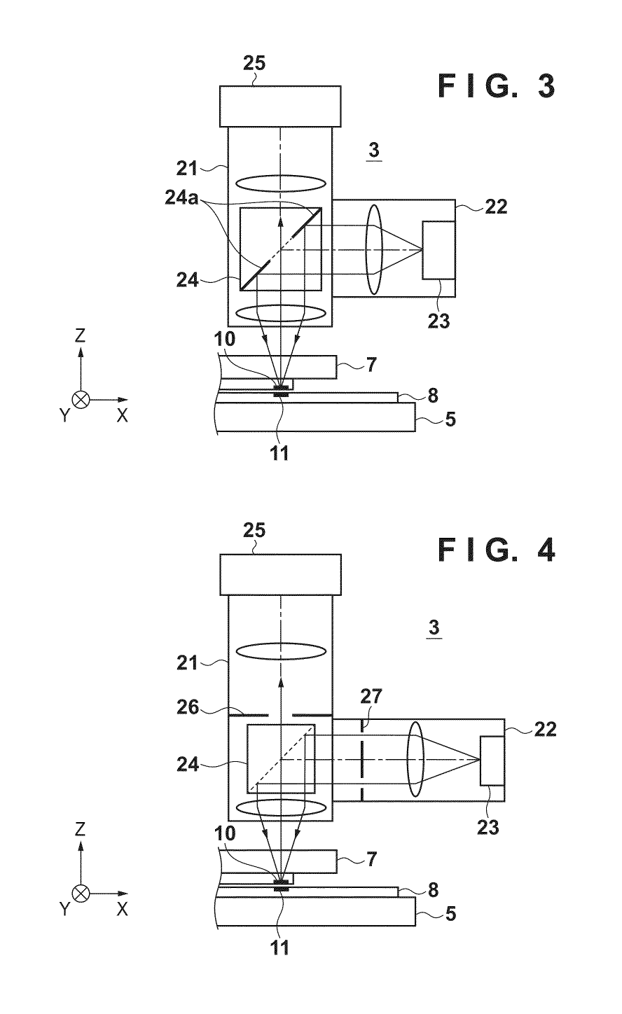

The detector 3, and the marks 10 and 11 arranged on the mold 7 and substrate 8, respectively, will be described in detail. FIG. 3 is a view illustrating an example of the configuration of the detector 3 in this embodiment. The detector 3 includes a detection optical system 21 and illumination optical system 22. The illumination optical system 22 guides light from a light source 23 onto the optical axis of the detection optical system 21 via, for example, a prism 24, and simultaneously obliquely illuminates the marks 10 and 11.

The light source 23 uses, for example, a halogen lamp or an LED, and is configured irradiate the resin 9 with visible rays or infrared rays, other than ultraviolet rays that cure the resin 9. The detection optical system 21 and illumination optical system 22 are configured to partially share an optical member which forms them, and the prism 24 is arranged on the pupil planes of the detection optical system 21 and illumination optical system 22 or in their vicinity. The marks 10 and 11 are respectively formed by grid patterns, and the detection optical system 21 forms, on an image sensing element 25, an image of interfering light (interference fringes or moire fringes) generated by interference between light beams diffracted by the marks 10 and 11 illuminated by the illumination optical system 22. A CCD or a CMOS, for example, is used as the image sensing element 25.

The prism 24 has, on its bonding surface, a reflective film 24a for reflecting light on the peripheral portion of the pupil plane of the illumination optical system 22. The reflective film 24a also serves as a stop provided with an aperture which defines the size (or detection NA: NAₒ) of the pupil of the detection optical system 21. The reflective film 24a moreover serves as a stop which forms light intensity distributions (effective light sources) IL1 to IL4 on the pupil plane of the illumination optical system 22. Alternatively, the prism 24 may serve as, for example, a half prism having a translucent film on its bonding surface, or a plate-shaped optical element having a reflective film deposited on its surface in place of a prism. The position at which the prism 24 according to this embodiment is arranged need not always be the pupil planes of the detection optical system 21 and illumination optical system 22 or their vicinity. In this case, stops 26 and 27 having individual apertures are arranged on the pupil planes of the detection optical system 21 and illumination optical system 22, respectively, as shown in FIG. 4. The stop 27 forms the light intensity distributions (effective light sources) IL1 to IL4 on the pupil plane of the illumination optical system 22. A half prism having a translucent film on its bonding surface, for example, is used as the prism 24.

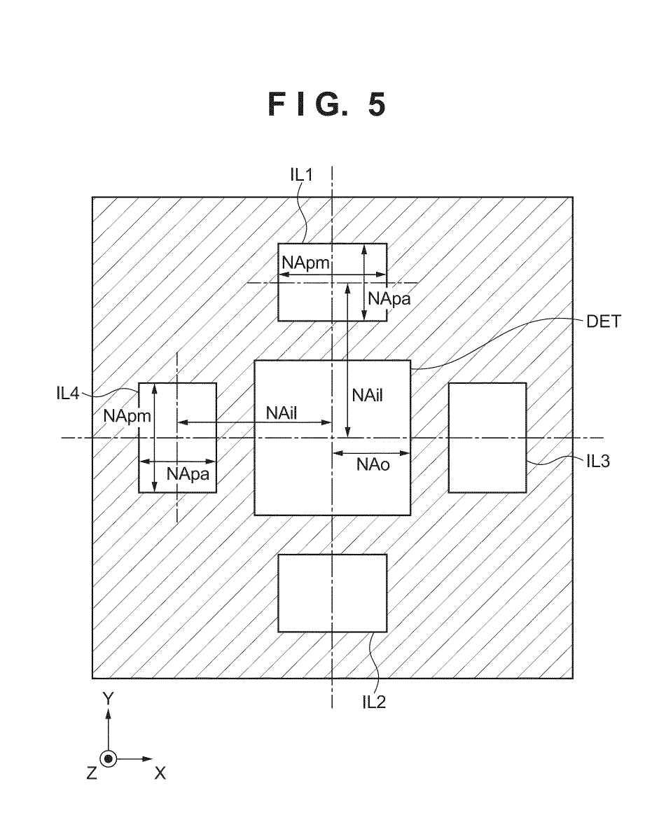

FIG. 5 shows the relationship between the light intensity distributions (effective light sources) IL1 to IL4 formed on the pupil plane of the illumination optical system 22, and an aperture (detection aperture) DET of the detection optical system 21. Referring to FIG. 5, the sizes of the effective light sources IL1 to IL4 of the illumination optical system 22, and the detection aperture DET of the detection optical system 21 are represented by the numerical apertures NA. The illumination optical system 22 forms an effective light source including the first pole IL1, second pole IL3, third pole IL2, and fourth pole IL4 on its pupil plane. Each of the four poles IL1 to IL4 has an NAₚₘ×NAₚₐ rectangular shape. The centers of the first pole IL1 and third pole IL2 are spaced apart from coordinate position (0, 0) by NAᵢ₁ in the ±Y-directions, respectively. The centers of the second pole IL3 and fourth pole IL4 are spaced apart from coordinate position (0, 0) by NAᵢ₁ in the ±X-directions, respectively. That is, the illumination optical system 22 is configured to obliquely illuminate the marks 10 and 11, and an incident angle θ on the marks 10 and 11 is given by:

θ=sin⁻¹(NAᵢ₁) (1)

The detection aperture DET of the detection optical system 21 is a square having its center at coordinate position (0, 0), and a side length of 2×NAₒ. The illumination optical system 22 and detection optical system 21 are configured so that NAₒ, NAₚₐ, and NAᵢ₁ satisfy:

NAₒ<NAᵢ₁−NAₚₐ/2 (2)

That is, the detector 3 has a dark-field configuration which does not detect specular reflection light (0th-order diffracted light) from either of the marks 10 and 11.

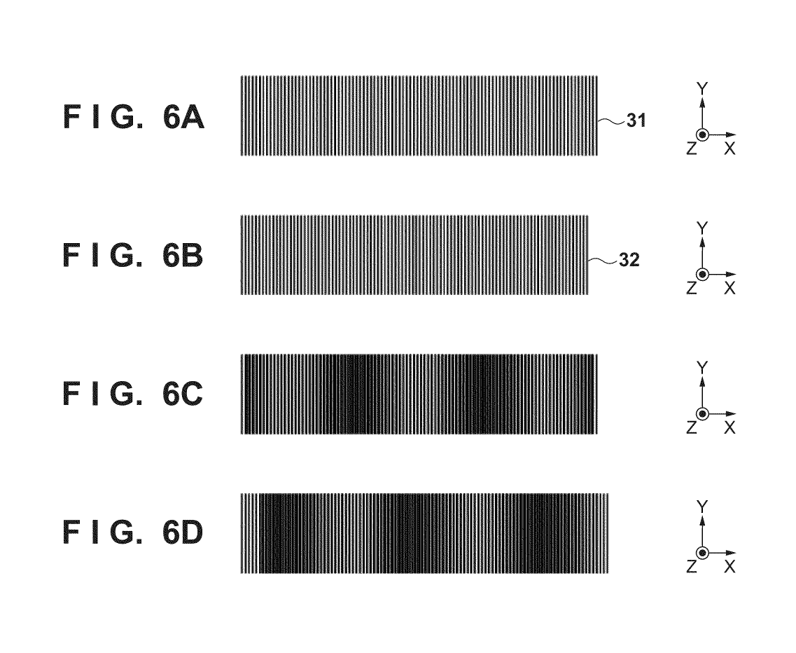

Detection of the relative position between the mold 7 and the substrate 8 using the principle of generation of moire fringes, and the moire fringes will be described. When grid patterns 31 and 32 having slightly different grid pitches, as shown in FIGS. 6A and 6B, are superposed on each other, light beams diffracted by the two grid patterns 31 and 32 interfere with each other, so interference fringes (moire fringes) having a period that reflects the difference in grid pitch, as shown in FIG. 6C, are generated. The light and dark positions (fringe phase) of the moire fringes change depending on the relative positional relationship between the two grid patterns 31 and 32. When, for example, one of the grid patterns 31 and 32 slightly shifts in the X-direction, the moire fringes shown in FIG. 6C change, as shown in FIG. 6D. Because the moire fringes enlarge the actual amount of shift of the relative position between the grid patterns 31 and 32, and are generated as fringes having a long period, the relative positional relationship between two objects can be measured with high accuracy even if a detection optical system 21 having a low resolution is used.

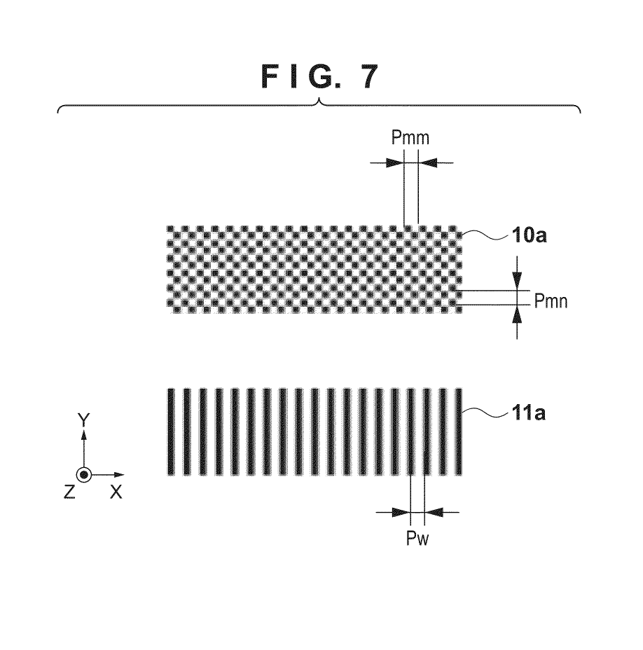

When the grid patterns 31 and 32 are detected in a light field (when illumination is performed from the vertical direction, and diffracted light is detected from the vertical direction) to detect the moire fringes (interfering light), the detector 3 also detects 0th-order diffracted light beams from the grid patterns 31 and 32. The 0th-order diffracted light beam from the grid pattern 31 or 32 leads to a decrease in contrast of the moire fringes. Hence, the detector 3 in this embodiment has a dark-field configuration which detects no 0th-order diffracted light, as described earlier. To allow detection of the moire fringes in a dark-field configuration which performs oblique illumination as well, one of the marks 10 and 11 on the mold and substrate sides serves as a checkerboard grid pattern, as shown in FIG. 7, and the other serves as a grid pattern shown in FIG. 6A or 6B. Although basically the same holds true when either of the marks 10 and 11 on the mold and substrate sides serves as a checkerboard grid pattern, the case wherein the mark 10 on the mold side serves as a checkerboard grid pattern will be taken as an example.

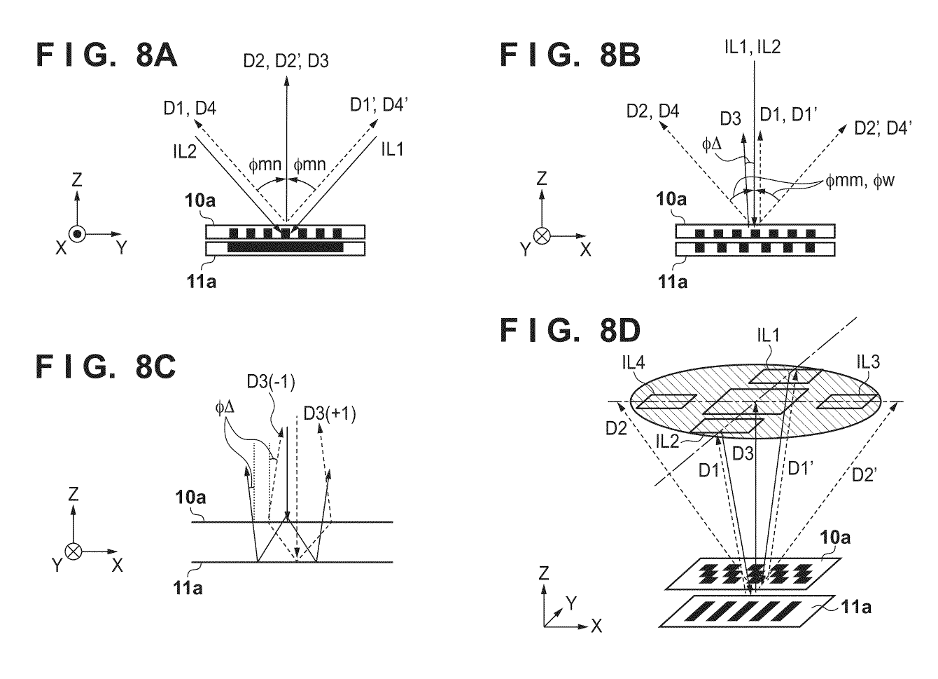

FIG. 7 shows the mark (first mark) 10 on the mold side and the mark (second mark) 11 on the substrate side, which are used to detect the relative position between the mold (first object) 7 and the substrate (second object) 8 in the X-direction (first direction). The mark 10 on the mold side includes a checkerboard grid pattern 10a having a grid pitch Pₘₘ in the X-direction and a grid pitch Pₘₙ in the Y-direction. The mark 11 on the substrate side includes a grid pattern 11a having a grid pitch P_{w} different from the grid pitch Pₙₘ only in the X-direction. The principle in which the detector 3 detects moire fringes while the two grid patterns 10a and 11a are superposed on each other will be described with reference to FIGS. 8A to 8D.

FIGS. 8A and 8B are views showing the grid patterns 10a and 11a from the X- and Y-directions, respectively. Moire fringes for detecting the relative position in the X-direction are generated by the light intensity distributions IL1 and IL2 of the first and third poles juxtaposed on the Y-axis in the pupil plane. A diffraction angle φ generated by the grid patterns 10a and 11a is expressed as:

sin φ=nλ/d (3)

where d is the grid pitch, λ is the wavelength of light emitted by the illumination optical system 22, and n is the order of diffraction.

Then, we have:

sin φₘₘ=nλ/Pₘₘ (4)

sin φₘₙ=nλ/Pₘₙ (5)

sin φ_{w}=nλ/P_{w} (6)

where φₘₘ and φₘₙ are the diffraction angles in the X- and Y-directions, respectively, generated by the grid pattern 10a, and φ_{w} is the diffraction angle generated by the grid pattern 11a.

Referring to FIG. 8A, the grid patterns 10a and 11a are obliquely illuminated along the Y-direction (non-measurement direction) by the light intensity distributions IL1 and IL2 of the first and third poles juxtaposed on the Y-axis that coincides with the non-measurement direction in the pupil plane. Light beams (0th-order diffracted light beams) D1 and D1′ specularly reflected by the grid patterns 10a and 11a are not incident on the detection optical system 21 because the detector 3 satisfies relation (2).

Reference symbols D2 and D2′ denote diffracted light beams having undergone ±1st-order diffraction only by the grid pattern 10a on the mold side; D3, a diffracted light beam having undergone +/−1st-order diffraction by the grid pattern 10a on the mold side, and −/+1st-order diffraction by the grid pattern 11a on the substrate side. The diffracted light beam D3 is used by the detector 3 to detect the relative position between the mold 7 and the substrate 8. The light beams D2, D2′, and D3 diffracted by the angle φₘₙ by the grid pattern 10a on the mold side, that has the grid pitch Pₘₙ in the Y-direction, emerge at an angle detected by the detection optical system 21 with respect to the Y-axis.

In this embodiment, to detect the diffracted light beam D3 which has undergone the grid pattern 10a and −/+1st-order diffraction by the grid pattern 11a, and has a relatively high diffraction intensity among diffracted light beams other than the 0th-order diffracted light beam, the detector 3 satisfies a condition which defines Pₘₙ, NAₒ, NAᵢ₁, and NAₚₐ as:

|NAᵢ₁−|sin φₘₙ||=|NAᵢ₁−λ/Pₘₙ|<NAₒ+NAₚₐ/2 (7)

In other words, the detector 3 can detect light diffracted in the Y-direction at a wavelength λ that falls within the range defined by relation (7).

The diffracted light beam D3 can be most efficiently detected when it travels perpendicularly to the Y-direction. Hence, letting λ_{c} be the central wavelength of illumination light output from the light source, the illumination conditions of the illumination optical system 22, and the grid pitch Pₘₙ of the grid pattern 10a on the mold side desirably are adjusted to satisfy:

NAᵢ₁−λ_{c}/Pₘₙ=0 (8)

As described above, the grid pattern 10a on the mold side is obliquely illuminated for the Y-direction (non-measurement direction), and a light beam diffracted in the non-measurement direction by the grid pattern 10a is detected.

A light beam diffracted in the X-direction (first direction), that is, the measurement direction will be described with reference to FIG. 8B. Light beams having the light intensity distributions IL1 and IL2 of the first and third poles juxtaposed on the Y-axis in the pupil plane are incident on the grid patterns 10a and 11a from a direction perpendicular to the X-axis. Assuming +/−1st-order diffracted light as in the case of the Y-direction, a diffracted light beam D3 having undergone +/−1st-order diffraction by the grid pattern 10a on the mold side, and −/+1st-order diffraction by the grid pattern 11a on the substrate side is incident on the detection optical system 21 at a small angle with respect to the X-axis because Pₙₘ and P_{w} are close to each other.

FIG. 8C shows how the diffracted light beam D3 is diffracted. Solid arrows indicate diffracted light beams which have undergone +/−1st-order diffraction by the grid pattern 10a on the mold side, and −/+1st-order diffraction by the grid pattern 11a on the substrate side, and are transmitted through the mold 7. Also, dotted arrows indicate diffracted light beams which are transmitted through the grid pattern 10a on the mold side, and have undergone −/+1st-order diffraction by the grid pattern 11a on the substrate side, and +/−1st-order diffraction by the grid pattern 10a on the mold side. A diffraction angle φ_{Δ} at this time is expressed as:

sin φ_{Δ}=λ×|P_{w}−Pₘₘ|/(PₘₘP_{w}) (9)

When |P_{w}−Pₘₘ|/(PₘₘP_{w})=1/P_{Δ} in relation (9), we have:

sin φ_{Δ}=λ/P_{Δ} (10)

Relation (10) means that interference fringes having the period P_{Δ} are generated by the diffracted light beam D3. These interference fringes serve as moire fringes having a pitch, which depends on the difference in grid pitch between the grid pattern 10a on the mold side and the grid pattern 11a on the substrate side. However, in this embodiment, the grid pattern 10a on the mold side is a checkerboard pattern, so generated moire fringes have a period P_{Δ}/2. At this time, a shift in relative position between the mold 7 and the substrate 8 enlarges a shift in position between the light and dark portions of the moire fringes, so the mold 7 and substrate 8 can be aligned with high accuracy even if a detection optical system 21 having a low resolution is used.

The light beams D2 and D2′ having undergone 1st-order diffraction only by the grid pattern 10a on the mold side, or light beams D4 and D4′ having undergone 1st-order diffraction only by the grid pattern 11a on the substrate side emerge at the angle φₘₘ or φ_{w} (FIG. 8B). The light beams D2, D2′, D4, and D4′ become noise without generating moire fringes, so it is desired not to detect them by the detection optical system 21. Hence, in this embodiment, the grid pitches Pₘₘ and P_{w} of the grid patterns 10a and 11a, and the numerical aperture NAₒ of the detection aperture DET of the detector 3 are adjusted to satisfy:

NAₒ+NAₚₘ/2<|sin φₘₘ|=λ/Pₘₘ (11)

NAₒ+NAₚₘ/2<|sin φ_{w}|=λ/P_{w} (12)

Light beams (0th-order diffracted light beams D1 and D1′ shown in FIG. 8B) which are not diffracted in the X-direction by either the grid pattern 10a on the mold side or the grid pattern 11a on the substrate side emerge at an angle detected by the detection optical system 21 with respect to the X-axis. Diffracted light beams D5 and D5′ having undergone +/−nth-order diffraction and −/+nth-order diffraction (0th-order diffraction in total) in the X-direction by the grid pattern 10a on the mold side before and after reflection by the substrate 8 without diffraction by the grid pattern 11a on the substrate side emerge at an angle detected by the detection optical system 21 with respect to the X-axis. The diffracted light beams D5 and D5′ generate no moire fringes, and lead to a decrease in contrast of the moire fringes. However, in this embodiment, the grid pattern 10a on the mold side is a checkerboard pattern, so the light beams D5 and D5′ diffracted by adjacent grids become n out of phase with each other, that is, cancel each other. Therefore, moire fringes can be measured with high contrast while the intensities of the diffracted light beams D5 and D5′ are kept low. FIG. 8D is a view showing a three-dimensional configuration of the configurations shown in FIGS. 8A and 8B. Note that the diffracted light beams D5 and D5′ have intensities that are kept low, and are not shown in FIG. 8D.

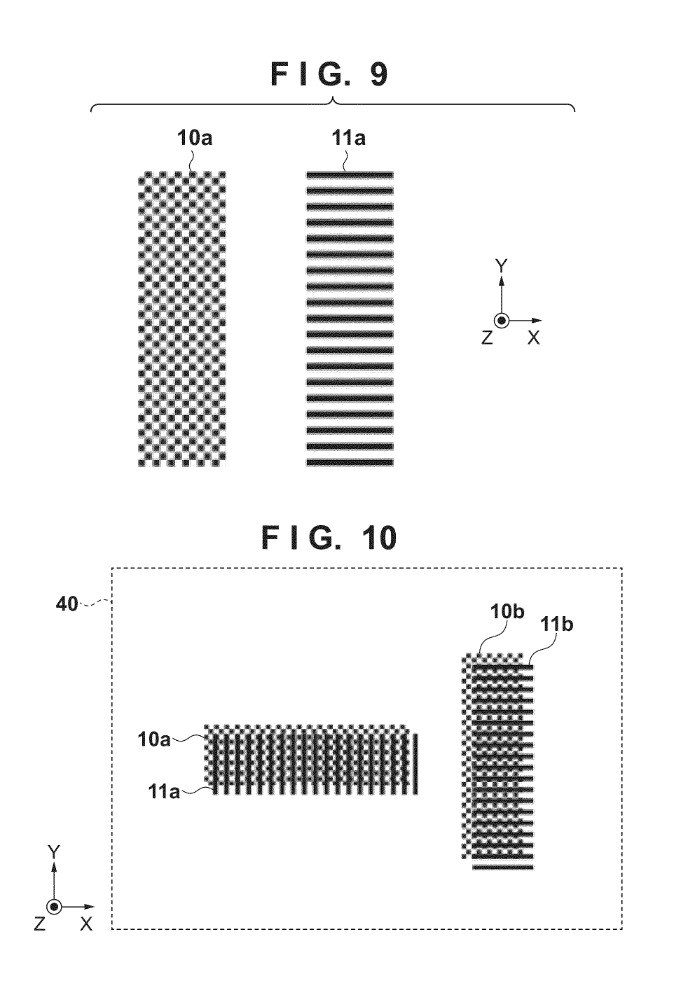

Detection of moire fringes for measuring the relative position between the mold 7 and the substrate 8 in the X-direction has been described above. However, basically the same holds true for detection of moire fringes for measuring the relative position between the mold 7 and the substrate 8 in the Y-direction, upon interchanging the mark and illumination directions between the X- and Y-directions. That is, a checkerboard grid pattern 10b having a grid pitch Pₘₙ in the X-direction and a grid pitch Pₘₘ in the Y-direction is used for the mark 10 for alignment in the Y-direction on the mold side. Also, a grid pattern 11b having a grid pitch P_{w} different from the grid pitch Pₘₘ only in the Y-direction is used for the mark 11 for alignment in the Y-direction on the substrate side (FIG. 9). Moire fringes for measuring the relative position between the mold 7 and the substrate 8 in the Y-direction are generated by illuminating the two grid patterns 10b and 11b using the light intensity distributions of the second pole IL3 and fourth pole IL4 juxtaposed on the Y-axis in the pupil plane.

Although the case wherein the grid patterns 10a and 10b have the same period, and the grid patterns 11a and 11b have the same grid pitch has been described above, the present invention is not limited to this. That is, the grid patterns 10a and 10b may have different grid pitches, and the grid patterns 11a and 11b may have different grid pitches as well. Moreover, the distances from the optical axis of the detection optical system 21 to the centers of the first and third poles IL1 and IL2 may be different from those from the optical axis of the detection optical system 21 to the centers of the second and fourth poles IL3 and IL4, respectively.

To detect one set of moire fringes, the detector 3 in this embodiment obliquely illuminates alignment marks along two directions and detects them from the vertical direction, so it can ensure an amount of light twice that of the conventional detector which obliquely illuminates the marks along only one direction and detects them. With this operation, the detector 3 can detect the relative position between two objects with high accuracy. As described above, although the detector 3 in this embodiment can detect diffracted light at a wavelength λ that falls within the range defined by relation (7), this wavelength range desirably is as wide as possible.

The mark 11 formed on the substrate 8 is less likely to be exposed on the surface of the substrate 8, and is likely to be formed inside a layered structure formed upon the process, including several to several ten stacked layers. When a layer made of a transparent substance is formed above the mark 11, the intensity of light which returns from the mark 11 may be very weak due to so-called thin-film interference, depending on the wavelength of the illumination light. At this time, changing the wavelength of the illumination light cancels the conditions under which thin-film interference occurs, thus allowing observation of the mark 11. Based on this fact, the conditions under which optimum detection is possible can desirably be set in accordance with the process of fabricating the substrate 8 by making the wavelength λ of the illumination light variable in a wide range when the mark 11 is observed by the detector 3. The conditions to be determined include, for example, the mark grid pitch, the numerical aperture NAₒ, the center positions of the first and second poles, and the wavelength range and central wavelength of the illumination light. The wavelength λ of the illumination light may be selected by extracting a desired wavelength range by, for example, a bandpass filter using a light source having wavelengths in a wide range, such as a halogen lamp, as the light source 23, or may be selected by switching between a plurality of monochromatic light sources having different central wavelengths, such as LEDs.

Marks formed by stacking the grid patterns 10a and 11a on each other, and the grid patterns 10b and 11b on each other, as shown in FIG. 10, are set to simultaneously fall within the fields of the effective light sources IL1 to IL4 and the detector 3 having the detection aperture DET, as shown in FIG. 5. This makes it possible to simultaneously observe sets of moire fringes for alignment in the X- and Y-directions using one detector 3. That is, in this embodiment, one detector 3 (detection optical system 21 and illumination optical system 22) with a relatively inexpensive, simple apparatus configuration can simultaneously obtain relative position information between two directions.

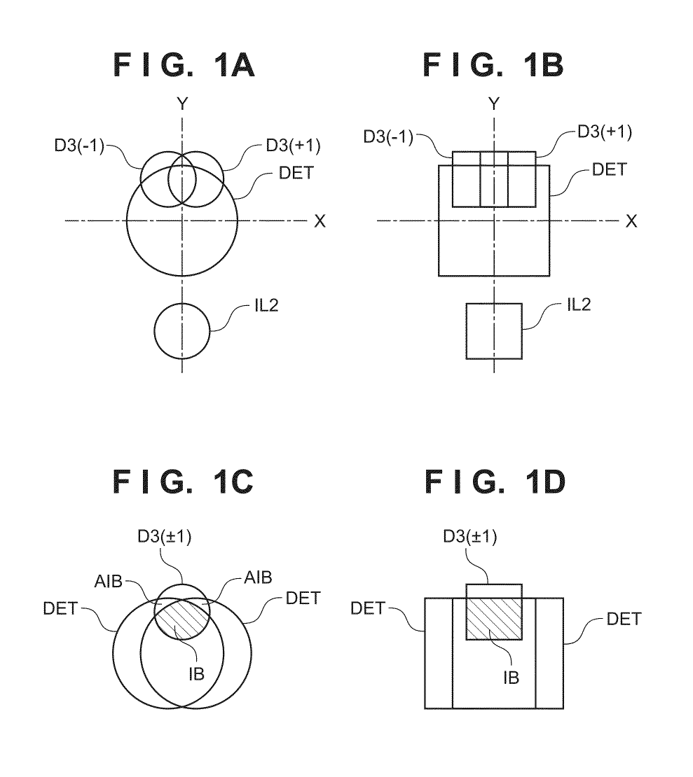

The effect of this embodiment will be explained with reference to FIGS. 1A to 1D. FIG. 1A is a schematic view of a conventional detector including an illumination optical system having a circular effective light source, and a detection optical system having a circular detection aperture. On the other hand, FIG. 1B is a schematic view of a detector according to this embodiment, which includes an illumination optical system having a rectangular effective light source, and a detection optical system having a rectangular detection aperture. The sizes of the effective light sources and detection apertures are defined by setting the diameter of the circle shown in FIG. 1A equal to the side length of the rectangle shown in FIG. 1B. For the sake of simplicity, FIGS. 1A and 1B show the detection aperture DET and only one effective light source IL2. Reference symbols D3(+1) and D3(−1) denote diffracted light beams from the effective light source IL2 used to detect the relative position between the mold 7 and the substrate 8. FIGS. 1A and 1B show the case wherein light of the effective light source IL2 on the long wavelength range side is partially eclipsed by the detection aperture DET. Under this condition, the ratios between light which contributes to interference and that which does not contribute to the interference for the circular and rectangular shapes are converted with reference to illumination light, as shown in FIGS. 1C and 1D.

FIG. 1C shows the case wherein the effective light source IL2 and detection apertures DET have circular shapes. When the detection apertures DET are superposed on the diffracted light beam D3(±1) while being decentered from each other, the overlapping region can be divided into a hatched region IB which can be measured by both the ±1st-order diffracted light beams, and regions AIB, each of which can be measured by one of the ±1st-order diffracted light beams. Note that since ±1st-order diffracted light beams are required to obtain interference, the hatched region IB is irradiated with light which contributes to interference, while the regions AIB are irradiated with bias light which does not contribute to interference.

On the other hand, if the detection apertures DET have a rectangular shape, as shown in FIG. 1D, only a hatched region IB irradiated with light which contributes to interference is present, while no regions AIB irradiated with light which does not contribute to interference are present, for the diffracted light beam D3(±1). Hence, the maximum contrast, that is, the ratio between interfering light and bias light is IB/(IB+AIB) when the detection apertures DET have a circular shape shown in FIG. 1C, while a maximum contrast IB/IB=1 can be obtained when the detection apertures DET have a rectangular shape shown in FIG. 1D. By forming a rectangular detection aperture DET, the contrast can be prevented from decreasing in a wavelength range in which the effective light source IL2 is eclipsed by the detection aperture DET.

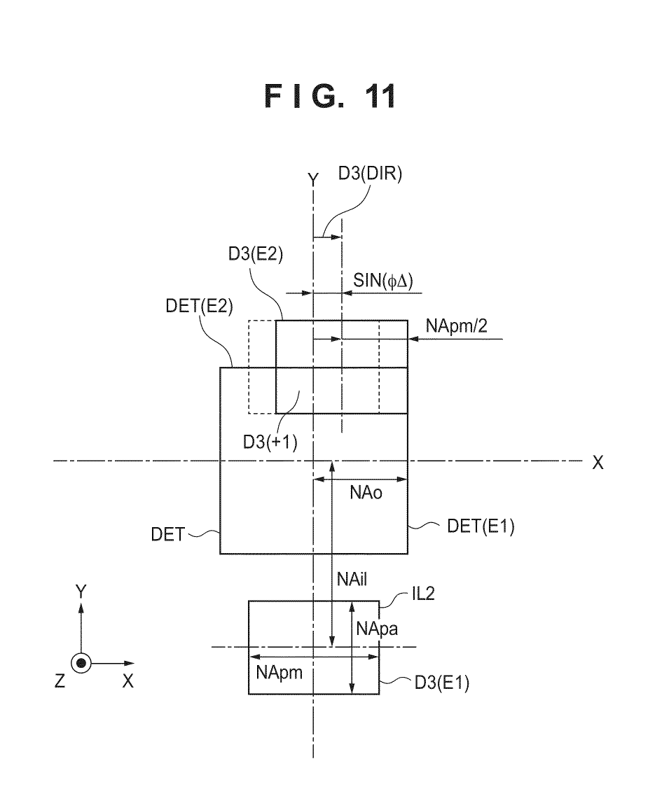

FIG. 11 is a view for explaining the shapes of the effective light source IL2 and detection aperture DET using relations. FIG. 11 shows the effective light source IL2, detection aperture DET, and +1st-order diffracted light beam D3(+1) in the pupil region. The sizes of the effective light source IL2 and detection aperture DET are the same as in FIG. 5. The diffraction NA of the diffracted light beam D3 (+1) is SIN(φ_{Δ}), as in relation (9). When the diffracted light beam D3(+1) is eclipsed by the detection aperture DET, it becomes unwanted light which does not contribute to interference. The condition in which the diffracted light beam D3(+1) is not eclipsed by the detection aperture DET in the X-direction is given by:

sin φ_{Δ}+NAₚₘ/2≦NAₒ (13)

NAₚₘ is equal to the length Lₚₘ in the first direction, that is, the measurement direction of one pole IL2, and NAₒ is a half of the length Lₚₘ in the first direction of the detection aperture DET. Therefore, the condition in which the diffracted light beam D3(+1) is not eclipsed by the detection aperture DET in the X-direction is rewritten as:

sin φ_{Δ}+Lₚₘ/2≦Lₒ/2 (13′)

In the wavelength range of the light source, the diffracted light beam D3(+1) is eclipsed by one horizontal side DET(E2) of the detection aperture DET. When a direction D3(DIR) in which the diffracted light beam D3(+1) is diffracted is different from the direction of one side DET(E2) of the detection aperture DET, the eclipsed state or condition varies in the ±1st-order diffracted light beams, so light which does not contribute to interference is detected. It is therefore desired to satisfy a condition:

D3(DIR)//DET(E2) (14)

When equality of relation (13) and relation (14) are satisfied, the amount of light which contributes to interference can be maximized by determining NAₚₘ and the shape of the effective light source IL2 so as to satisfy a condition:

D3(E1)//DET(E1) (15)

Therefore, when both the effective light source IL2 and the detection aperture DET have rectangular shapes, and relations (13), (14), and (15) are satisfied, the amount and contrast of light which contributes to interference maximize.

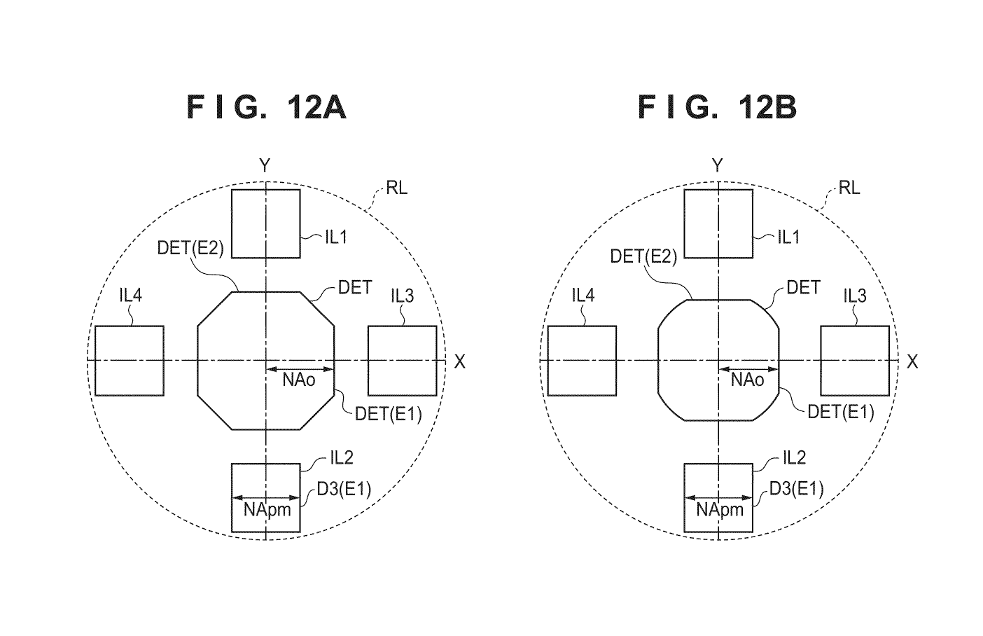

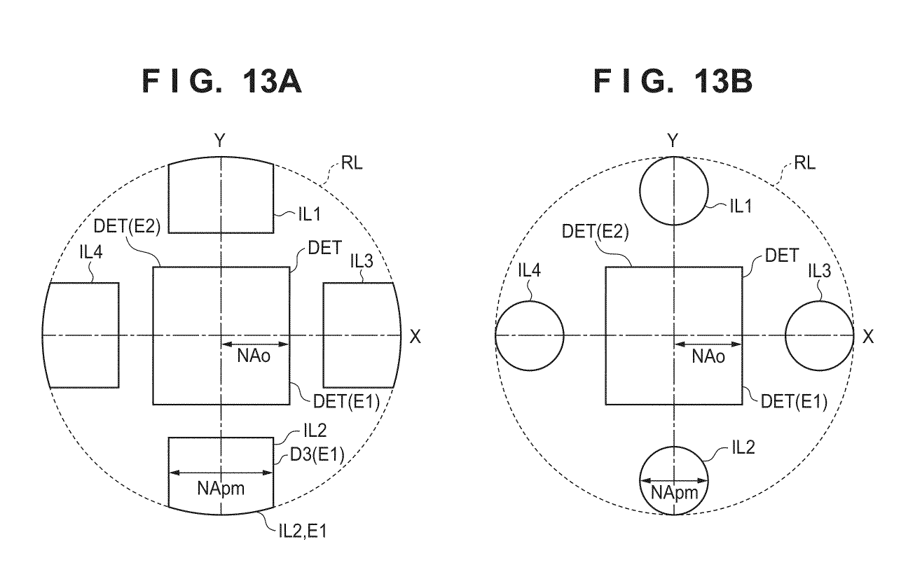

The effective light sources IL1 to IL4 and detection apertures DET shown in FIGS. 12A and 12B or 13A and 13B almost satisfy relations (13) to (15). However, when the shapes of the effective light source and detection aperture are constrained by another constraint such as aberration, they can be changed without departing from the object and effect of the present invention, as shown in FIGS. 12A and 12B or 13A and 13B.

Referring to FIGS. 12A and 12B, the detection aperture DET has a boundary including a pair of segments (line segments) parallel to the X-direction and those parallel to the Y-direction. Referring to FIG. 12A, segments parallel to the X-direction and those parallel to the Y-direction are connected to each other by straight lines. A broken line RL indicates the maximum pupil diameter of the detector 3. Referring again to FIG. 12A, the shape of the detection aperture DET is an octagon formed by cutting the four corners of a rectangle. Even in the shape shown in FIG. 12A, if the amount of cutting of the corners of a rectangle is not large, it is possible to keep the amounts of decrease in contrast and amount of light small. As in the example shown in FIG. 12A, the shape of the detection aperture DET can be an octagon or a polygon other than an octagon. Referring to FIG. 12B, segments parallel to the X-direction and those parallel to the Y-direction are connected to each other by arcuated curves, and the boundary of the detection aperture DET has a shape formed by curves and straight lines. Even in the shape shown in FIG. 12B, it is possible to keep the amounts of decrease in contrast and amount of light small, depending on the amount of cutting of the corners of a rectangle. Relations (13) to (15) can almost be satisfied in both a shape other than a polygon formed by straight lines alone, and a shape formed by curves and straight lines.

FIGS. 13A and 13B are explanatory views when the effective light sources IL1 to IL4 have deformed from a rectangle. Referring to FIG. 13A, each of the effective light sources IL1 to IL4 has a shape which is formed by straight lines and a curve and has a boundary including segments parallel to the X-direction, that parallel to the Y-direction, and part of the outer periphery of the pupil plane of the illumination optical system 22. A curve IL2(E1) represents a plane obtained by cutting the effective light source IL2 from a rectangle in accordance with the maximum pupil diameter RL of the detector 3. Even in the shape shown in FIG. 13A, relations (13) to (15) are satisfied, so it is possible to effectively use light that falls below the maximum pupil diameter of the detection optical system 21 to maximize the amount of light. FIG. 13B is an explanatory view when a rectangular detection aperture DET and circular effective light sources IL1 to IL4 are used. Referring to FIG. 13B, the contrast has a maximum value when relations (13) and (14) are satisfied. It is obvious that the object of the present invention can also be achieved by combining the detection apertures DET shown in FIGS. 12A and 12B, and the effective light sources IL1 to IL4 shown in FIGS. 13A and 13B.

In this embodiment, the shapes of a detection aperture and effective light source which can maximize the contrast and the amount of light have been described. Although a scheme of simultaneous measurement operations in the X- and Y-directions has been described in this embodiment, the same mode can also be selected using a scheme of separate measurement operations in the X- and Y-directions. Also, although it is desired to widen the wavelength range to cope with the process in accordance with the structure of the mark 11 on the substrate side, the contrast does not decrease despite the widening of the wavelength range in the present invention. As described above, according to this embodiment, it is possible to detect only light which contributes to interference, thus improving the contrast. Also, the effective use of the pupil region of the detector 3 makes it possible to maximize the amount of light.

[Method of Manufacturing Article]

A method of manufacturing an article will be described. A method of manufacturing a device (for example, a semiconductor integrated circuit device or a liquid crystal display device) as an article includes a step of forming a pattern on a substrate (a wafer, a glass plate, or a film-like substrate) using the above-mentioned imprint apparatus. This method can also include a step of etching the substrate having the pattern formed on it. Note that when other articles such as a patterned medium (recording medium) and an optical element are to be manufactured, this method can include other processes of processing the substrate having the pattern formed on it, instead of etching. The method of manufacturing an article according to this embodiment is more advantageous in terms of at least one of the performance, quality, productivity, and manufacturing cost of an article than the conventional method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-040666, filed Feb. 27, 2012, which is hereby incorporated by reference herein in its entirety.

What is claimed is:

1. A detector which detects a relative position between a first object and a second object in a first direction, the detector comprising:
an illumination optical system configured to obliquely illuminate a first mark arranged on the first object, and a second mark arranged on the second object; and
a detection optical system configured to detect interfering light generated by light beams diffracted by the first mark and the second mark, respectively, illuminated by said illumination optical system,
wherein said illumination optical system forms a light intensity distribution including at least one pole on a pupil plane thereof,
said detection optical system includes a stop provided with an aperture on a pupil plane thereof, and
a shape of the aperture includes a side parallel to the first direction.

2. The detector according to claim 1, wherein a shape of the aperture includes a pair of sides parallel to the first direction and a pair of sides perpendicular to the first direction.

3. The detector according to claim 2, wherein the aperture has a rectangular shape.

4. The detector according to claim 2, wherein each of the pair of sides parallel to the first direction, and each of the pair of sides perpendicular to the first direction are connected to each other by one of a straight line and a curve.

5. The detector according to claim 1, wherein the at least one pole has a pair of sides parallel to the first direction and a pair of sides perpendicular to the first direction.

6. The detector according to claim 1, wherein the at least one pole has a side parallel to the first direction, a side perpendicular to the first direction and a part of an outer periphery of the pupil plane of said illumination optical system.

7. The detector according to claim 1, wherein a diffraction angle φ_{Δ} of diffracted light which generates the interfering light, a length Lₒ of the aperture in the first direction, and a length Lₚₘ of the at least one pole in the first direction satisfy sinφ_{Δ}+Lₚₘ/2≦Lₒ/2.

8. An imprint apparatus which brings a pattern formed on a mold into contact with an imprint material supplied on a substrate, and cures the imprint material to form a pattern on the substrate,
the imprint apparatus comprising
a detector configured to detect a first mark arranged on the mold, and a second mark arranged on the substrate,
said detector including:
an illumination optical system configured to obliquely illuminate a first mark arranged on the first object, and a second mark arranged on the second object; and
a detection optical system configured to detect interfering light generated by light beams diffracted by the first mark and the second mark, respectively, illuminated by said illumination optical system,
wherein said illumination optical system forms a light intensity distribution including at least one pole on a pupil plane thereof,
said detection optical system includes a stop provided with an aperture on a pupil plane thereof, and
the aperture has a boundary including a segment parallel to the first direction.

9. A method of manufacturing an article, the method comprising:
forming a pattern on a substrate, using an imprint apparatus which presses a pattern of a mold against an imprint material on a substrate, and cures the imprint material to form a pattern of the cured imprint material on the substrate; and
processing the substrate having the pattern formed thereon to manufacture the article,
the imprint apparatus comprising
a detector configured to detect a first mark arranged on the mold, and a second mark arranged on the substrate,
the detector including:
an illumination optical system configured to obliquely illuminate a first mark arranged on the first object, and a second mark arranged on the second object; and
a detection optical system configured to detect interfering light generated by light beams diffracted by the first mark and the second mark, respectively, illuminated by the illumination optical system,
wherein the illumination optical system forms a light intensity distribution including at least one pole on a pupil plane thereof,
the detection optical system includes a stop provided with an aperture on a pupil plane thereof, and
a shape of the aperture includes a side parallel to the first direction.
